(19) United States
(12) Patent Application Publication
(10) Pub. No.: US 2024/0266088 A1
(43) Pub. Date: Aug. 8, 2024

(54) POWER SUPPLY CABLE AND CONNECTOR-EQUIPPED POWER SUPPLY CABLE

(71) Applicant: Fujikura Ltd., Tokyo (JP)

(72) Inventors: Randeep Singh, Tokyo (JP); Akihiro Takamiya, Tokyo (JP); Yoji Kawahara, Tokyo (JP); Tsuyoshi Ogawa, Tokyo (JP); Ichiro Terunuma, Sakura-shi (JP); Takahiro Suga, Sakura-shi (JP)

(73) Assignee: Fujikura Ltd., Tokyo (JP)

(21) Appl. No.: 18/567,242

(22) PCT Filed: Feb. 3, 2022
(86) PCT No.: PCT/JP2022/004310

§ 371 Date: Dec. 5, 2023

(30) Foreign Application Priority Data
Jun. 11, 2021 (JP) 2021-097989

(51) Int. Cl. H01B 7/42; F28D 15/04; F28D 21/00

(52) U.S. Cl. CPC H01B 7/423; F28D 15/046; F28D 2021/0029

(57) ABSTRACT

A power supply cable includes a heat pipe including a container and an insulating layer formed on an outer periphery of the container, and a plurality of power lines disposed radially outside the heat pipe and including conductive wires.

### CROSS-REFERENCE TO RELATED APPLICATIONS

The present application claims priority to Japanese Patent Application No. 2021-097989, filed Jun. 11, 2021. The contents of this application are incorporated herein by reference in their entirety.

### BACKGROUND

### Technical Field

The present invention relates to a power supply cable and a connector-equipped power supply cable.

### Description of the Related Art

In the related art, a power supply cable as disclosed in Patent Document 1 has been known. This power supply cable includes an electric wire including a conductor and a coating portion that coats the electric wire, and a filling is disposed in a gap portion between the electric wire and the coating portion. The filling is a material having a low thermal resistance and can transfer heat generated by the conductor to the coating portion to radiate the heat.

### Patent Document

Patent Document 1: Japanese Patent Publication No. 2012-146542

In a case in which a battery for an electric car is quickly charged by using a power supply cable, for example, a large current of 400 A or more flows through a power line. In a state in which such a large current flows, the temperature of the power supply cable rises in some cases, and thus it is necessary to restrict the temperature of the power supply cable within a predetermined range.

### SUMMARY

One or more embodiments provide a power supply cable and a connector-equipped power supply cable, which can be efficiently cooled even in a case in which a large current flows.

A first aspect of one or more embodiments relates to a power supply cable including a heat pipe including a container and an insulating layer formed on an outer periphery of the container, and a plurality of power lines disposed radially outside the heat pipe and including conductive wires.

According to the aspect described above, it is possible to efficiently cool the power supply cable even in a case in which a large current flows through the conductive wire. In a case in which a large current of 400 A or more is made to flow, it is necessary to design a large cable diameter in the power supply cable in the related art which does not have a cooling method using the heat pipe, and a cable weight is increased in some cases. On the other hand, because the cooling can be efficiently performed by using the heat pipe, the diameter or the weight of the cable according to the aspect described above can be reduced in the power supply cable.

In addition, in the cooling method using the heat pipe, it is possible to cool the cable without using an auxiliary power source from the outside. Because an electrical short circuit due to the auxiliary power source or a conductor for the auxiliary power source does not occur, a safer cooling method can be provided. In addition, even in a case in which the cable length is longer than the length of the cable in the related art, the cooling can be appropriately performed over the entire length. Because the power supply cable can be appropriately cooled, deterioration of constituent materials can be prevented, and the life of a product can be prolonged. Further, because a large current can be made to flow through the power supply cable, the electric car can be quickly charged.

In addition, the heat pipe may have a loop shape and may extend from a first end portion and a second end portion of the power supply cable.

In addition, the heat pipe may have a line shape, and may extend from a first end portion and a second end portion of the power supply cable.

In addition, the plurality of power lines may include a positive potential power line used at a positive potential and a negative potential power line used at a negative potential.

In addition, the container may include a corrugated portion in which a protrusion portion protruding radially outward and a recess portion recessed radially inward are alternately disposed along a longitudinal direction of the heat pipe.

In addition, a plurality of grooves may be formed on an inner surface of the container in the corrugated portion, and the grooves may extend spirally along the longitudinal direction of the heat pipe.

In addition, at least a portion of the heat pipe extending from an end portion of the power supply cable may be flat when viewed at a cross section thereof.

In addition, a condensation portion in which a working fluid is condensed in the heat pipe may be located at a higher position in a vertical direction than an evaporation portion in which the working fluid is evaporated in the heat pipe.

In addition, in the heat pipe, an inner diameter of the container in a liquid phase movement portion in which a working fluid in a liquid phase is moved may be smaller than an inner diameter of the container in a gas phase movement portion in which a working fluid in a gas phase is moved.

A second aspect of one or more embodiments relates to a connector-equipped power supply cable including the power supply cable described above, and a connector provided in a first end portion of the power supply cable and being connectable to a power supply source, in which the connector includes a connector terminal, and the connector terminal is in contact with the heat pipe extending from the power supply cable.

According to one or more embodiments described above, it is possible to provide the power supply cable and the connector-equipped power supply cable, which can be efficiently cooled even in a case in which a large current flows.

### BRIEF DESCRIPTION OF THE DRAWINGS

FIG. 1 is a cross sectional view of a power supply cable according to a first example.

FIG. 2 is a schematic view of the power supply cable and a connector according to the first example.

FIG. 3 is a side view of a heat pipe as viewed from a radial outside.

FIG. 4 is a sectional view taken along a line IV-IV of the heat pipe of FIG. 2.

FIG. 5 is a schematic view of a power supply cable and a connector according to a second example.

FIG. 6 is a cross sectional view of a power supply cable according to a third example.

FIG. 7 is a schematic view of the power supply cable and a connector according to the third example.

FIG. 8 is a schematic view for describing a modification example of the power supply cable.

FIG. 9 is a schematic view for describing another modification example of the power supply cable.

FIG. 10 is a schematic view for describing still another modification example of the power supply cable.

### DESCRIPTION OF THE EMBODIMENTS

### First Example

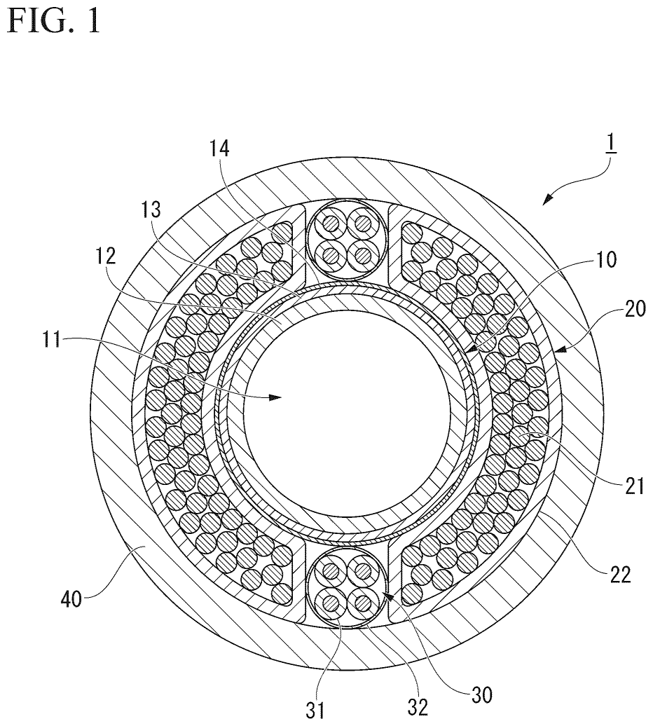

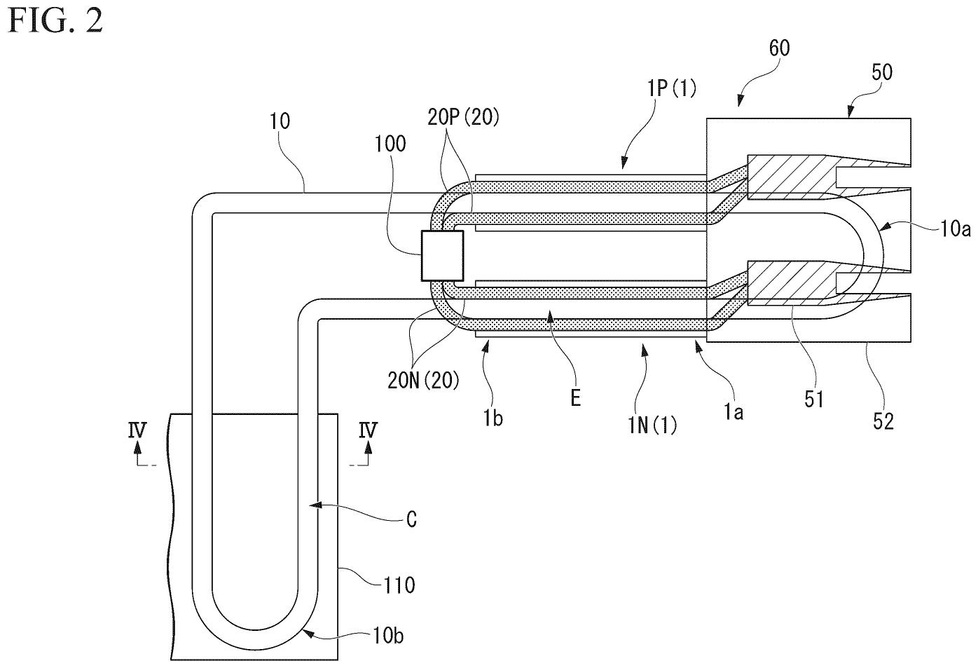

Hereinafter, a configuration of a power supply cable 1 according to one or more embodiments will be described based on the drawings. As shown in FIGS. 1 and 2, the power supply cable 1 includes a heat pipe 10, a plurality of power lines 20, a plurality of communication cords 30, and a sheath 40.

### (Definition of Direction)

In one or more embodiments, a direction along a central axis of the power supply cable 1 is referred to as a longitudinal direction. Also, in a cross sectional view orthogonal to the central axis, a direction orthogonal to the central axis is referred to as a radial direction, and a direction orbiting the central axis is referred to as a circumferential direction.

### (Heat Pipe 10)

As shown in FIG. 1, the heat pipe 10 includes a wick 12, a container 13, and an insulating layer 14. The heat pipe 10 is a heat transfer element that transfers heat by using latent heat of a working fluid enclosed in the container 13.

The container 13 is a hollow container having a cylindrical shape. The container 13 is formed of, for example, metal. Exemplary examples of the metal forming the container 13 include copper, steel, aluminum, and the like. In one or more embodiments, a copper tube is used as the container 13.

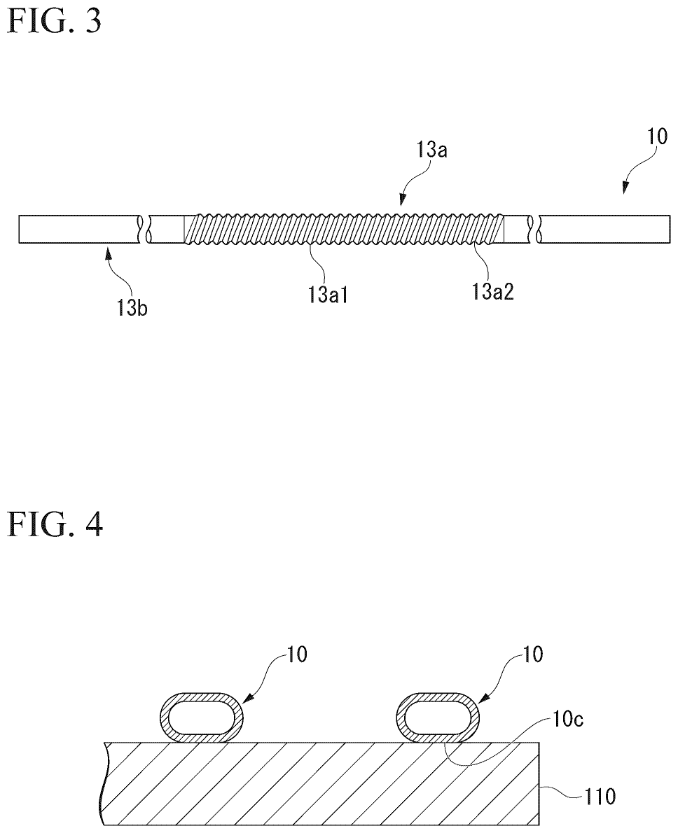

There is a case in which the power supply cable 1 is required to be easily bent in a portion such that the power supply cable 1 can be easily wired inside a car along a wire harness. Therefore, as shown in FIG. 3, the container 13 of the heat pipe 10 includes a corrugated portion 13a that has been corrugated, and a non-corrugated portion 13b that has not been corrugated, in the longitudinal direction.

In the corrugated portion 13a, the container 13 includes a plurality of protrusion portions 13al protruding radially outward and a plurality of recess portions 13a2 recessed radially inward, and the protrusion portions 13al and the recess portions 13a2 are alternately formed along the longitudinal direction.

The plurality of protrusion portions 13al and the plurality of recess portions 13a2 of the corrugated portion 13a in FIG. 3 are spirally formed along an outer peripheral surface and an inner peripheral surface of the container 13 having a tubular shape. Such a corrugated shape is formed, for example, by heating and twisting a copper tube having a cylindrical shape. The corrugated shape may be formed by applying pressing force from the radial outside of the container 13 having a tubular shape. However, the protrusion portion 13al and the recess portion 13a2 do not have to be spiral and may be ring-shaped. In the corrugated portion 13a, the heat pipe 10 can be bent according to a purpose.

As shown in FIG. 1, the insulating layer 14 is formed on the outer peripheral surface of the container 13. The insulating layer 14 is formed of a material having an insulating property, and has a thickness of, for example, about 0.1 to 0.5 mm. Even in a case in which electric leakage occurs in the power supply cable 1, the presence of the insulating layer 14 makes it possible to prevent an electrical short circuit via the heat pipe 10.

It is preferable that the insulating layer 14 is formed of a material having a low thermal resistance. In this case, the heat generated in a conductive wire 21 can be efficiently transferred into the heat pipe 10.

The working fluid is enclosed in an internal space 11 of the container 13. The working fluid is a well-known heat transfer medium capable of undergoing a phase change, and undergoes the phase change between a liquid phase and a gas phase in the container 13. As the working fluid, for example, water, alcohol, ammonia, and the like can be adopted. Alternatively, a refrigerant, such as R134a or the like, may be adopted as the working fluid. It should be noted that, in the present specification, in some cases, the working fluid in the liquid phase is referred to as “working liquid”, and the working fluid in the gas phase is referred to as “steam”. In addition, in a case in which the liquid phase and the gas phase are not particularly distinguished, the working fluid is simply referred to as the working fluid. The working fluid is not shown.

The wick 12 is disposed in the container 13.

The wick 12 is formed along the inner peripheral surface of the container 13 as shown in FIG. 1, for example. The wick 12 may be formed only in a partial region in the circumferential direction and the longitudinal direction on the inner peripheral surface of the container 13.

The wick 12 is formed by, for example, bundling a plurality of thin metal wires, for example, thin copper wires. The thin copper wire is a wire body extending in the longitudinal direction of the container 13. The wick 12 is, for example, a plurality of thin copper wires. The outer diameter of the thin copper wire is, for example, several μm to several hundred μm.

A gap extending in the longitudinal direction is formed between the thin copper wires. The gap is used as a liquid flow path for the working liquid to flow, and serves as a reflux path (hereinafter, referred to as a “flow path”) for the working liquid to reflux from a condensation portion C to an evaporation portion E. The working liquid in the flow path flows in the longitudinal direction due to capillary force.

The wick 12 is not limited to thin metal wire, and a metal mesh (net-like body), a sintered body of a metal powder, and the like can also be used.

Exemplary examples of the metal forming the wick 12 include copper, aluminum, stainless steel, and alloys thereof. The wick 12 is not limited to being formed of metal and may be formed of a carbon material and the like. For example, the wick 12 may be formed of a thin carbon wire, a carbon mesh, and the like.

### (Power Line 20)

Each power line 20 includes a plurality of conductive wires 21 and an insulation coating 22. For example, a DC current of 400 A or more flows through the conductive wire 21.

In the cross-sectional view shown in FIG. 1, each power line 20 is formed in an arc shape along the outer peripheral surface of the heat pipe 10. In addition, the power supply cable 1 includes two power lines 20, and both the power lines 20 are disposed to interpose the heat pipe 10 radially outside the heat pipe 10.

The conductive wire 21 is formed by bundling and twisting a plurality of core wire. As the core wire forming the conductive wire 21, for example, a tin-plated annealed copper wire can be used. Since the plurality of conductive wires 21 are disposed in an arc shape along a curved surface of the outer peripheral surface of the heat pipe 10, the conductive wires 21 are cooled without bias in the circumferential direction.

It should be noted that the number of the conductive wires 21 and the number of the core wires included in one power line 20 can be changed as appropriate.

The insulation coating 22 coats the conductive wires 21. As the material of the insulation coating 22, for example, EP rubber can be used.

In one or more embodiments, the power supply cable 1 includes two power lines 20, and each of the power lines 20 is disposed to be in contact with the outer peripheral surface of the heat pipe 10. It should be noted that, although not shown, in a case in which the corrugated portion 13a of the heat pipe 10 is disposed inside the power supply cable 1, a gap extending along the recess portion 13a2 may be formed between the heat pipe 10 and the power line 20.

### (Communication Cord 30)

The communication cord 30 is used, for example, for communication between a vehicle, which is a power supply target, and a power supply source. The communication cord 30 is disposed radially outside the heat pipe 10. In the cross-sectional view shown in FIG. 1, two communication cords 30 are disposed to interpose the heat pipe 10 in the radial direction, and are disposed at the same positions as the power lines 20 in the circumferential direction. In addition, the communication cords 30 and the power lines 20 are alternately disposed in the circumferential direction. The outer diameters of the two communication cords 30 are substantially the same as each other and are the same as a thickness of the power line 20 in the radial direction.

The communication cord 30 includes four signal lines 31 and a coating 32 that wraps the signal lines 31. The signal line 31 has a configuration in which a conductor is coated with an insulation coating. In the communication cord 30, the signal lines 31 are wrapped in the coating 32 in a state of being spirally twisted together. In addition, the communication cord 30 has flexibility.

Each signal line 31 can be used, for example, for applications, such as a control of a lock mechanism of a connector 50 of the power supply cable 1, a power source line of an LED that is turned on when power is supplied, and a signal line of a temperature sensor in a case in which the connector 50 includes a temperature sensor. In addition, a part of the signal lines 31 may be used as an auxiliary power supply line to the power supply target.

The sheath 40 coats the heat pipe 10, the power line 20, and the communication cord 30. The power line 20 and the communication cord 30 may be linearly disposed along the heat pipe 10 or may be spirally wound around the heat pipe 10. The sheath 40 can be formed by extrusion molding or the like using, for example, chloroprene rubber and the like.

FIG. 2 is a schematic view of a connector-equipped power supply cable 60 including the power supply cable 1. It should be noted that the communication cord 30 is not shown.

The connector-equipped power supply cable 60 includes two power supply cables 1 and a power supply connector (hereinafter simply referred to as a connector 50) disposed in a first end portion 1a of each power supply cable 1.

The power supply cable 1 according to one or more embodiments is disposed inside the electric car (vehicle), and for example, is used to electrically connect a connector-equipped lead cable (electric car charging gun) (not shown) extending from a charging stand for the electric car and a battery 100 of the electric car to supply power to the battery 100. A length in the longitudinal direction of the power supply cable 1 can be, for example, about 0.5 to 1.5 m, but can be changed as appropriate according to a length from the connector 50 to the battery 100. For example, the connector 50 is disposed in the vicinity of a side surface of the vehicle and is covered with a lid (not shown) except during charging.

The connector 50 that can be connected to the connector of the lead cable is disposed in the first end portion 1a of the power supply cable 1. At a second end portion 1b of the power supply cable 1, the power line 20 is electrically connected to the battery 100 of the power supply target. In one or more embodiments, the power supply target will be described as the battery 100 of the electric car (vehicle); however, a power supply target other than the battery 100 may also be used.

In one or more embodiments, a power line 20P of one power supply cable 1 (first power supply cable 1P) is used at a positive potential, and a power line 20N of the other power supply cable 1 (second power supply cable IN) is used at a negative potential.

### (First End Portion 1a of Power Supply Cable 1)

The connector 50 includes a plurality of connector terminals 51 and a case 52. The case 52 is formed of, for example, a material, such as plastic, and accommodates the first end portion 10a of the heat pipe 10 extending from the first end portion 1a of the power supply cable 1, and the connector terminal 51.

Each of the connector terminals 51 is electrically connected to the conductive wire 21 in the power line 20. The connector terminal 51 is a female connector having a hole into which a terminal of the connector of the lead cable is inserted. In the example of FIG. 2, two connector terminals 51 are disposed, and each of them is connected to each of the power line 20P used at the positive potential or the power line 20N used at the negative potential.

In the connector 50, the heat pipe 10 of the power supply cable 1 extends. The heat pipe 10 according to one or more embodiments has a loop shape, and the first end portions 10a of the two heat pipes 10 disposed in the two power supply cables 1P and IN are connected to each other in the connector 50. Hereinafter, the description will be made by giving a reference numeral 10a to the first end portions of the two heat pipes 10 connected to each other.

In the connector 50, the corrugated portion 13a of the heat pipe 10 may be disposed, or the non-corrugated portion 13b may be disposed. The two heat pipes 10 may be connected to each other by a connection tube (not shown).

In the connector 50, the heat pipe 10 and the connector terminal 51 are in contact with each other. As a result, the heat generated in the connector terminal 51 can be transferred by the heat pipe 10.

### (Second End Portion 1b of Power Supply Cable 1)

At the second end portion 1b of the power supply cable 1, the power line 20 and the heat pipe 10 extend. The extending power line 20 is connected to the battery 100.

The heat pipe 10 extending from the second end portion 1b of the power supply cable 1 extends to a cooling device disposed in a vehicle body and is disposed to be in contact with the cooling device. The cooling device according to one or more embodiments is a cold plate 110. For example, the extending portion of the heat pipe 10 may be disposed on an empty space of the cold plate 110 for cooling the battery 100. It should be noted that the heat pipe 10 may be disposed to be in indirect contact with the cold plate 110. That is, a filling that conducts the heat may be disposed between the heat pipe 10 and the cold plate 110.

In FIG. 2, the cold plate 110 and the battery 100 are disposed apart from each other, but the cold plate 110 may be disposed to be in contact with the battery 100 to cool the battery 100. Alternatively, the cold plate 110 and the battery 100 may be disposed apart from each other and may be connected to each other by a heat transfer element (such as another heat pipe). By cooling the heat pipe 10 by using the cold plate 110 for the battery 100, it is not necessary to further install a cooling device (heat sink or the like) of the power supply cable 1 to the inside of the vehicle body, and thus the space can be saved.

The corrugated portion 13a may be formed in a part of the heat pipe 10 extending from the second end portion 1b of the power supply cable 1. As a result, the heat pipe 10 can reach the cold plate 110 while partially bending the heat pipe 10.

The second end portions 10b of the two heat pipes 10 are connected to each other. Hereinafter, the description will be made by giving a reference numeral 10b to the second end portions of the two heat pipes 10 connected to each other. The second end portions 10b of the two heat pipes 10 may be connected to each other by a connection tube (not shown).

As shown in FIG. 4, the heat pipe 10 is flat when viewed at a cross section thereof in a portion in contact with the cold plate 110, that is, has a shape in which a width of a surface in contact with the cold plate 110 is larger than a thickness thereof. A cross section of the container 13 has a substantial oval shape. The term “oval shape” is a shape formed by two linear portions 10c that are parallel and face each other, and a curve having a curved protrusion shape (for example, a semicircular shape, an elliptical arc shape, or the like) that connects both end portions of these two linear portions 10c.

As shown in FIG. 4, the linear portion 10c of the heat pipe 10 is disposed to be in contact with the cold plate 110. As a result, a contact area between the heat pipe 10 and the cold plate 110 can be increased, and thus the heat can be transferred more efficiently. As shown in FIG. 2, a U-shaped portion in the second end portion 10b in which the two heat pipes 10 are connected to each other may be disposed on the cold plate 110. In this case, the heat can be transferred from the heat pipe 10 to the cold plate 110 even in the U-shaped portion.

It should be noted that the insulating layer 14 shown in FIG. 1 may be provided over the entire heat pipe 10. In this case, the insulating layer 14 is interposed between the cold plate 110 and the container 13, and the heat is transferred via the insulating layer 14.

In this way, both the heat pipes 10 included in the power supply cables 1P and IN are connected to each other in the first end portion 10a and the second end portion 10b and have a loop shape.

### [Heat Transfer Cycle]

Next, a heat transfer cycle by the heat pipe 10 will be described. When the power line 20 and the connector terminal 51 are energized, the temperature rises, so that the working liquid in the heat pipe 10 is evaporated in the vicinity of the power supply cable 1 and the connector 50. That is, the vicinity of the power line 20 and the connector terminal 51 serves as the evaporation portion E of the heat pipe 10. In the evaporation portion E, the working liquid that permeates into the flow path of the wick 12 is evaporated.

The steam generated in the evaporation portion E flows through the internal space 11 toward the second end portion 10b side (portion in which the heat pipe 10 extends from the power supply cable 1) of the heat pipe having a lower pressure and temperature than the evaporation portion E. In the portion in which the heat pipe 10 is in contact with the cold plate 110, a part of the steam is condensed. That is, a portion of the heat pipe 10 disposed in the cold plate 110 serves as the condensation portion C. The working liquid generated in the condensation portion C permeates into the flow path of the wick 12, and flows through the flow path by the capillary force to reflux from the condensation portion C to the evaporation portion E.

The working liquid that refluxes to the evaporation portion E is evaporated again in the evaporation portion E. The working liquid repeats the cycle (heat transfer cycle) in which the working liquid is evaporated in the evaporation portion E, is condensed in the condensation portion C, and refluxes to the evaporation portion E. As a result, it is possible to cool the power line 20 and the connector terminal 51.

As described above, the power supply cable 1 according to one or more embodiments includes the heat pipe 10 including the container 13 and the insulating layer 14 formed on the outer periphery of the container 13, and the plurality of power lines 20 disposed radially outside the heat pipe 10 and including the conductive wires 21.

As a result, it is possible to efficiently cool the power supply cable 1 even in a case in which a large current flows through the conductive wire 21. In a case in which a large current of 400 A or more is made to flow, it is necessary to design a large cable diameter in the power supply cable in the related art which does not have a cooling method using the heat pipe, and a cable weight is increased in some cases. On the other hand, since the cooling can be efficiently performed by using the heat pipe 10, the diameter or the weight of the cable can be reduced in the power supply cable 1 according to one or more embodiments.

In addition, in the cooling method using the heat pipe 10, it is possible to cool the cable without using an auxiliary power source from the outside. Since an electrical short circuit due to the auxiliary power source or a conductor for the auxiliary power source does not occur, a safer cooling method can be provided. In addition, even in a case in which the cable length is longer than the length of the cable in the related art, the cooling can be appropriately performed over the entire length. Since the power supply cable 1 can be appropriately cooled, deterioration of constituent materials can be prevented, and the life of a product can be prolonged.

Further, since a large current can be made to flow through the power supply cable 1, the electric car can be quickly charged.

In addition, the heat pipe 10 may have a loop shape, and may extend from the first end portion 1a and the second end portion 1b of the power supply cable 1. In this case, a rapid decrease in pressure of the steam (working fluid in the gas phase) can be suppressed. In addition, even in a case in which the length of the heat pipe 10 or the power supply cable 1 is long (for example, 5 m or more), the cooling can be satisfactorily performed over the entire length of the cable.

In addition, the container 13 may include the corrugated portion 13a in which the protrusion portion 13al protruding radially outward and the recess portion 13a2 recessed radially inward are alternately disposed along the longitudinal direction of the heat pipe 10.

The heat pipe 10 is easily bent in the portion in which the corrugated portion 13a is formed. Therefore, by forming the corrugated portion 13a in at least a portion of the heat pipe 10, the power supply cable 1 and the heat pipe 10 extending from the power supply cable 1 can be easily disposed in a limited space inside the vehicle body.

In addition, at least a portion of the heat pipe 10 extending from the second end portion 1b of the power supply cable 1 may be flat when viewed at a cross section thereof. As a result, the contact area between the cold plate 110 and the heat pipe 10 is increased, so that the heat can be exchanged efficiently.

The connector-equipped power supply cable 60 according to one or more embodiments includes the power supply cable 1, and the connector 50 provided in the first end portion 1a of the power supply cable 1 and being connectable to the power supply source, in which the connector 50 includes the connector terminal 51, and the connector terminal 51 is in contact with the heat pipe 10 extending from the power supply cable 1. As a result, it is also possible to efficiently cool the connector terminal 51 through which a large current flows.

### Second Example

Hereinafter, a second example according to one or more embodiments will be described, but the basic configuration is the same as the basic configuration of the first example. Therefore, the same reference numeral is given to the same configuration, the description thereof will be omitted, and only the difference will be described.

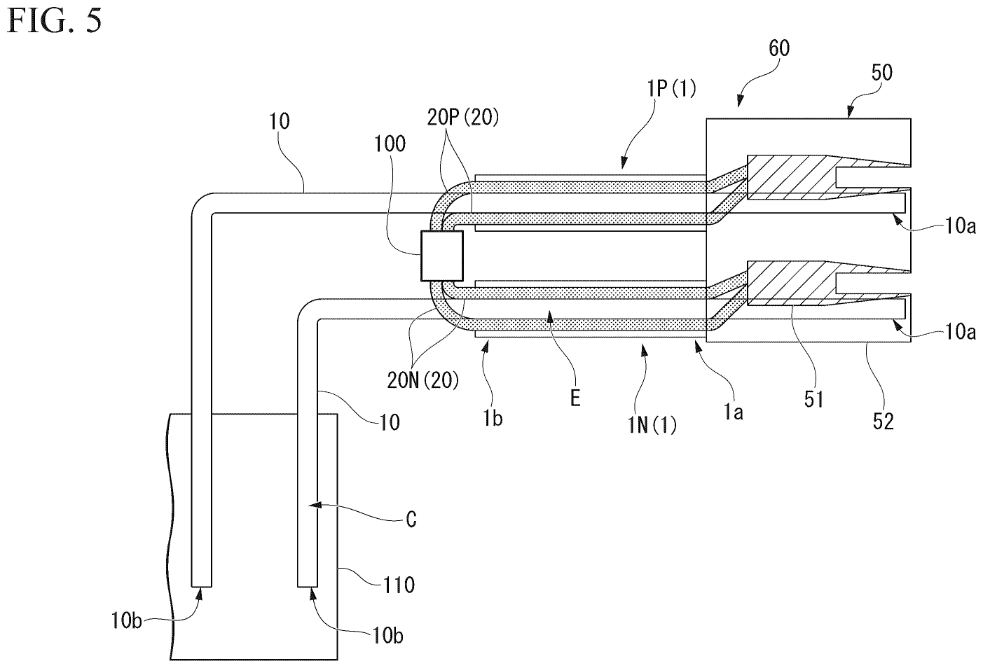

FIG. 5 shows the power supply cable 1 and the connector 50 according to the second example. The second example is different from the first example in that the heat pipe 10 has a line shape, and both the heat pipes 10 extending from the end portions of the two power supply cables 1 are not connected to each other. That is, the connector-equipped power supply cable according to one or more embodiments includes two independent heat pipes 10.

The heat pipe 10 extending from the first end portion 1a of the first power supply cable 1P is in contact with the connector terminal 51 on a positive side, and the heat pipe 10 extending from the first end portion 1a of the second power supply cable IN is in contact with the connector terminal 51 on a negative side.

In the connector 50, the first end portions 10a of the two heat pipes 10 are not connected to each other. In other words, both the first end portions 10a of the two heat pipes 10 are disposed apart from each other in the connector 50.

The heat pipe 10 extending from the second end portion 1b of the power supply cable 1 is formed to be flat in the second end portion 10b in contact with the cold plate 110. The second end portions 10b of the two heat pipes 10 are not connected to each other. In other words, both the second end portions 10b of the two heat pipes 10 are in contact with the cold plate 110 in a state of being apart from each other.

As described above, the heat pipe 10 according to one or more embodiments has a line shape, and extends from the first end portion 1a and the second end portion 1b of the power supply cable 1.

In one or more embodiments, as in the first example, the heat of the conductive wire 21 and the connector terminal 51 can be efficiently transferred by the heat pipe 10. Further, since the two heat pipes 10 are not connected to each other, a degree of freedom in disposition of the heat pipes 10 can be further increased.

### Third Example

Hereinafter, a third example according to one or more embodiments will be described, but the basic configuration is the same as the basic configuration of the first example. Therefore, the same reference numeral is given to the same configuration, the description thereof will be omitted, and only the difference will be described.

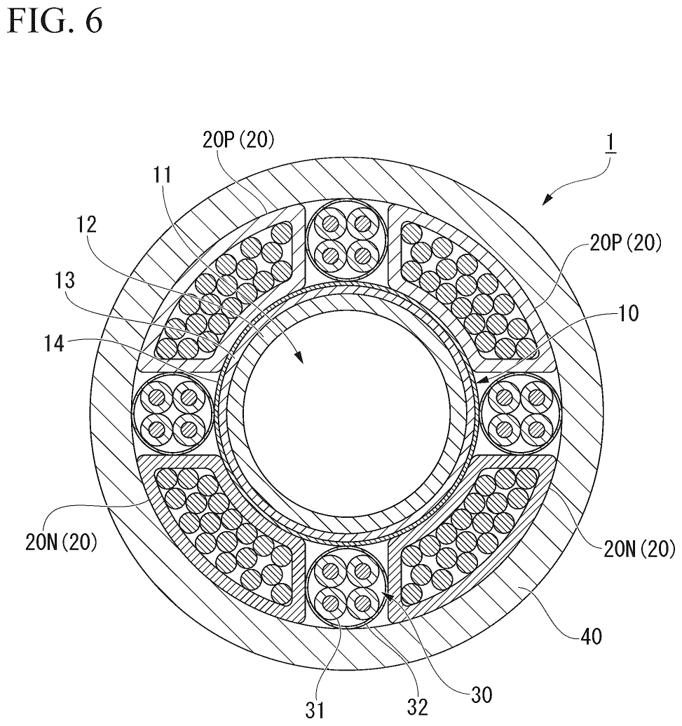

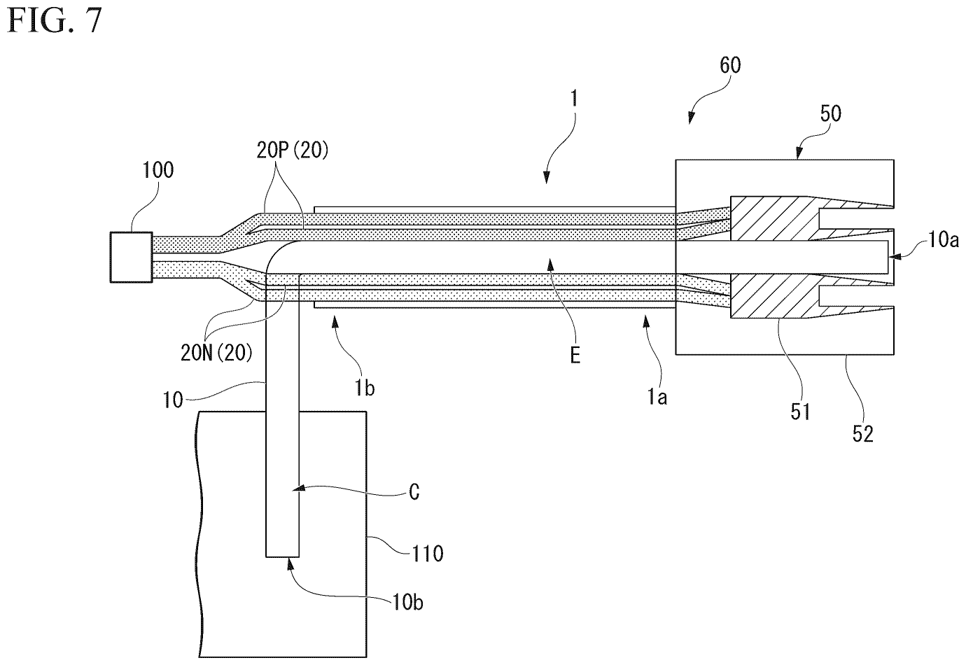

FIGS. 6 and 7 show the power supply cable 1 and the connector-equipped power supply cable 60 according to the third example.

Four power lines 20 are disposed in one power supply cable 1, two of the four power lines 20 are positive potential power lines 20P used at the positive potential, and the remaining two are negative potential power lines 20N used at the negative potential. As shown in FIG. 6, the two positive potential power lines 20P are disposed on a first side surface side (upper side of the paper in FIG. 6) of the power supply cable 1, and the two negative potential power lines 20N are disposed on a second side surface side (lower side of the paper in FIG. 6) of the power supply cable 1.

In the connector 50, the positive potential power line 20P is connected to the connector terminal 51 on the positive side, and the negative potential power line 20N is connected to the connector terminal 51 on the negative side.

The heat pipe 10 extending from the first end portion 1a of the power supply cable 1 is in contact with the two connector terminals 51.

The heat pipe 10 extending from the second end portion 1b of the power supply cable 1 is formed to be flat in the portion in contact with the cold plate 110.

As described above, in the power supply cable 1 according to one or more embodiments, the plurality of power lines 20 include the positive potential power line 20P used at the positive potential and the negative potential power line 20N used at the negative potential.

Since one power supply cable 1 includes the positive potential power line 20P and the negative potential power line 20N, the power supply cable 1 can be wired in a smaller space.

It should be noted that the technical scope of the present invention is not limited to the embodiments or examples described above, and various changes can be made without departing from the scope of the present invention.

For example, although the working liquid is moved by using the capillary force generated by the wick 12 in the embodiments described above, a configuration may be adopted in which the working liquid is moved without using the wick 12.

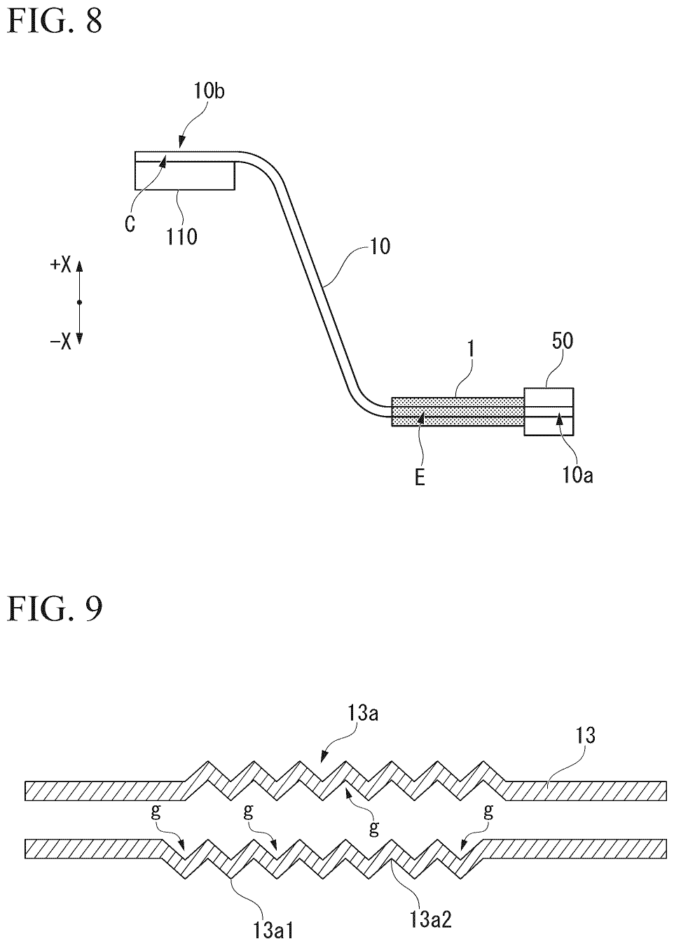

For example, as shown in FIG. 8, in a case in which the cold plate 110 is disposed on the upper side (+X side) and the connector 50 is disposed on the lower side (−X side) in the vertical direction, the second end portion 10b of the heat pipe 10 is disposed on the upper side (+X side) with respect to the first end portion 10a of the heat pipe 10. In this case, the condensation portion C is located at a higher position than the evaporation portion E in the vertical direction, and the working liquid can be moved by gravity, so that the wick 12 does not have to be disposed in the heat pipe 10. However, it is also possible to move the working liquid against gravity by using, for example, the capillary force generated by the wick 12. Therefore, the condensation portion C may be located at a lower position than the evaporation portion E in the vertical direction. In addition, the condensation portion C and the evaporation portion E may be at equivalent positions in the vertical direction.

In addition, as shown in FIG. 9, which displays a cross section of the corrugated portion 13a along the longitudinal direction, in a case of a configuration in which a plurality of grooves g are formed on the inner surface of the container 13 in the corrugated portion 13a, and the grooves g extend spirally along the longitudinal direction of the heat pipe 10, the working liquid can be moved along the longitudinal direction of the heat pipe 10 through the grooves g. Further, the working liquid may be moved by generating the capillary force in the groove g. In this case, the wick does not have to be disposed in the corrugated portion 13a. Alternatively, the groove g of the corrugated portion 13a and the wick 12 may be combined to form the flow path for the working liquid. It should be noted that, in the example shown in FIG. 9, on the inner surface of the container 13, the grooves g are formed in portions corresponding to the inner sides of the plurality of protrusion portions 13al of the corrugated portion 13a. However, the present invention is not limited to the example of FIG. 9, on the inner surface of the container 13, the grooves g may be formed in portions that do not correspond to the inner sides of the plurality of protrusion portions 13al of the corrugated portion 13a.

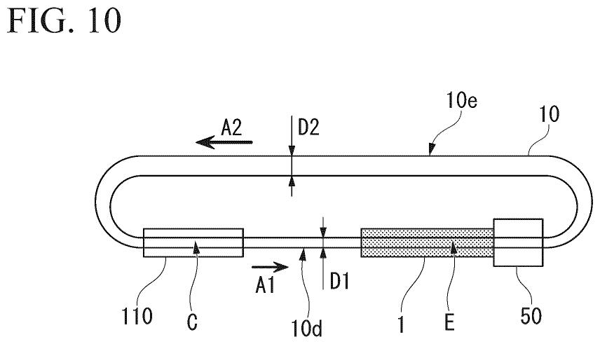

In addition, for example, as shown in FIG. 10, in the heat pipe 10 formed in a loop shape, the working liquid and the steam are moved to circulate in the same direction in some cases. In this case, the volume of the wick 12 disposed in the portion of the heat pipe 10 in which the steam is mainly moved may be smaller than the volume of the wick 12 in the portion in which the working liquid is mainly moved. Alternatively, the wick 12 does not have to be disposed at the portion in which the steam is mainly moved.

In the example shown in FIG. 10, the heat pipe 10 extends from both end portions of the one power supply cable 1 to be formed in a loop shape. The working fluid circulates inside the heat pipe 10 in the directions of arrows A1 and A2 in FIG. 10. More specifically, the heat pipe 10 having a loop shape includes a liquid phase movement portion 10d in which the working liquid is mainly moved toward the power supply cable 1 from the cold plate 110 side, and a gas phase movement portion 10e in which the steam is mainly moved to the cold plate 110 side from the power supply cable 1. The working liquid is moved in the direction indicated by the arrow A1 in the liquid phase movement portion 10d, and the steam is moved in the direction indicated by the arrow A2 in the gas phase movement portion 10e.

The working liquid has a much smaller volume than in a state in which the working fluid is steam. Therefore, a diameter (inner diameter) D1 of the container 13 of the liquid phase movement portion 10d can be made smaller than a diameter (inner diameter) D2 of the container 13 of the gas phase movement portion 10e. As a result, the diameter of the power supply cable 1 can be further reduced.

In a case in which the working fluid does not circulate in one direction, the steam and the working liquid are moved in the same tube in the container 13 of the heat pipe 10, and the movement directions face each other. As compared to this case, in the heat pipe 10 having a loop shape shown in FIG. 10, since the steam and the working liquid are moved in different portions, a loss of a steam pressure can be reduced.

By changing the shape or the disposition of the heat pipe 10 in this manner, the amount or the portion of the disposition of the wick 12 in the heat pipe 10 can be reduced. As a result, the weight of the heat pipe 10 can be reduced, and the heat pipe 10 can be more easily manufactured.

In addition, the heat pipe 10 may be flat in the first end portion 10a in contact with the connector terminal 51. Further, the heat pipe 10 may be deformed according to the shape of the connector terminal 51. As a result, it is possible to more efficiently cool the connector terminal 51.

In addition, the corrugated portion 13a of the heat pipe 10 may be formed over the entire length of the heat pipe 10 or may be formed only in a portion that is bent in a case of being disposed in the vehicle body. It should be noted that, since the power line 20 having the plurality of conductive wires 21 and the communication cord 30 having the plurality of signal lines 31 have flexibility, the power supply cable 1 including the heat pipe 10 including the corrugated portion 13a in at least a portion thereof can be easily deformed.

In addition, in the first end portion 10a and the second end portion 10b of the heat pipe 10, the corrugated portion 13a does not have to be formed in the portion in contact with the connector terminal 51 or the cold plate 110. Since the corrugated portion 13a is not formed, it is possible to increase the area in which the heat pipe 10 and the connector terminal 51 or the cold plate 110 are in direct contact with each other, and thus it is possible to increase the efficiency of heat exchange.

In addition, the insulating layer 14 of the heat pipe 10 is formed on the outer peripheral surface over the entire length of the heat pipe 10. As a result, an electrical short circuit via the heat pipe 10 can be more reliably prevented. It should be noted that the insulating layer 14 may be separated from the heat pipe 10 and may be disposed between the heat pipe 10 and the power line 20.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

### REFERENCE SIGNS LIST

1: Power supply cable
1a: First end portion
1b: Second end portion
10: Heat pipe
10a: First end portion of heat pipe
10b: Second end portion of heat pipe
11: Internal space
12: Wick
13: Container
13a: Corrugated portion
13a1: Protrusion portion
13a2: Recess portion
14: Insulating layer
20: Power line
20P: Positive potential power line
20N: Negative potential power line
21: Conductive wire
22: Insulation coating
30: Communication cord
40: Sheath
50: Connector
51: Connector terminal
60: Connector-equipped power supply cable
100: Battery
110: Cold plate
C: Condensation portion
E: Evaporation portion

1. A power supply cable comprising:
a heat pipe including:
a container; and
an insulating layer disposed on an outer periphery of the container; and
power lines disposed radially outside the heat pipe and including conductive wires.

2. The power supply cable according to claim 1, wherein the heat pipe has a loop shape and extends from a first end portion of the power supply cable and a second end portion of the power supply cable.

3. The power supply cable according to claim 1, wherein the heat pipe has a line shape and extends from a first end portion of the power supply cable and a second end portion of the power supply cable.

4. The power supply cable according to claim 1, wherein the power lines further include a positive potential power line and a negative potential power line.

5. The power supply cable according to claim 1, wherein the container includes a corrugated portion in which a protrusion portion protruding radially outward and a recess portion recessed radially inward are alternately disposed along a longitudinal direction of the heat pipe.

6. The power supply cable according to claim 5, wherein
an inner surface of the container in the corrugated portion has grooves, and
the grooves extend spirally along the longitudinal direction of the heat pipe.

7. The power supply cable according to claim 1, wherein a portion of the heat pipe extending from an end portion of the power supply cable is flat when viewed at a cross section of the heat pipe.

8. The power supply cable according to claim 1, wherein a condensation portion in which a working fluid is condensed in the heat pipe is disposed at a higher position in a vertical direction than an evaporation portion in which the working fluid is evaporated in the heat pipe.

9. The power supply cable according to claim 1, wherein, in the heat pipe, an inner diameter of the container in a liquid phase movement portion in which a working fluid in a liquid phase is moved is smaller than an inner diameter of the container in a gas phase movement portion in which a working fluid in a gas phase is moved.

10. A connector-equipped power supply cable comprising:
the power supply cable according to claim 1; and
a connector disposed in a first end portion of the power supply cable and configured to be connected to a power supply source, wherein
the connector includes a connector terminal that contacts the heat pipe extending from the power supply cable.
